(19) United States
(12) Patent Application Publication
(10) Pub. No.: US 2006/0127167 A1
(43) Pub. Date: Jun. 15, 2006

(54) Transverse quick-release connector

(76) Inventor: Wu-Hong Hsieh, Lu Chou City (TW)

Correspondence Address: BACON & THOMAS, PLLC, 625 SLATERS LANE, FOURTH FLOOR, ALEXANDRIA, VA, 22314, US

(21) Appl. No.: 11/010,510

(22) Filed: Dec. 14, 2004

(51) Int. Cl. F16B 7/10

(52) U.S. Cl. 403/109.5

(57) ABSTRACT

A transverse quick-release connector for a stand with a stanchion and an accessory has a body, a locking block and a lever. The body has a head, a stanchion socket and a locking cavity. The head is attached to the accessory for the stand. The stanchion socket is formed under the head to hold the stanchion. The locking cavity is formed in the stanchion socket and has an inner space to communicate with the blind hole in the stanchion socket. The locking block is movably mounted inside the locking cavity. The lever is pivotally attached to the body to press the locking block against the stanchion or to release the locking block and is selectively pushed right and left. The accessory can be quickly and easily attached or detached to the stanchion.

### BACKGROUND OF THE INVENTION

1. Field of the Invention

The present invention relates to a quick-release connector, and more particularly to a transverse quick-release connector for use with musical instrument stands, microphone booms and the like, which can be connected or disconnected quickly and easily.

2. Description of Related Art

Support stands are used to hold objects for musicians, performers, speakers, etc. For example, a music stand is used to hold a score or sheet music for a musician, and a microphone stand is used to support a microphone for singers, speakers and certain musicians.

With reference to FIG. 8, a conventional microphone stand is composed of a stanchion (50) and a boom (40).

The stanchion (50) is connected to a base and has a threaded top end (51).

The boom (40) is mounted at a variable angle on the stanchion (50) and has an adjustment sleeve and a pivot fitting. The boom (40) is mounted slidably in the adjustment sleeve. The pivot fitting has a bracket (41) and an adapter (43). The bracket (41) is attached to and extends out radially from the adjustment sleeve. The adapter (43) is connected pivotally to the bracket (41) and is screwed onto the threaded end (51) of the stanchion (50).

However, conventional support stands have the following drawbacks.

1. To attach the boom (40) to the stanchion (50), either the boom (40) has to be screwed onto the stanchion (50), or the stanchion (50) has to be screwed into the adapter (43) on the boom (40). However, the boom (40) is too long to rotate easily, and the stanchion (50) mounted in the base is too heavy to rotate easily. Therefore, attaching or detaching elements of the conventional support stand is difficult.

2. Screwing the boom (40) and the stanchion (50) together is time-consuming and threads defined on the threaded end (51) of the stanchion (50) and in the threaded hole in the stub (52) are easily damaged during assembly and transportation.

With further reference to FIG. 9, a conventional longitudinal quick-release connector (60) replaces the adapter (43) in the pivot fitting and comprises a body and a lever (70). The lever (70) is pushed upward or downward to lock or release the body on the stanchion (50). However, the lever (70) easily abuts the bracket (41) when the lever (70) is pushed upward, which makes pulling the lever (70) downward difficult.

To overcome the shortcomings, the present invention provides a transverse quick-release connector to mitigate or obviate the aforementioned problems.

### SUMMARY OF THE INVENTION

The main objective of the present invention is to provide a transverse quick-released connector a lever is pivoted right and left.

A transverse quick-release device for a stand with a stanchion and an accessory such as a boom, sheet music holder or the like has a body, a locking block and a lever.

The body has a head, a stanchion socket and a locking cavity. The head is attached to a support stand accessory such as a boom. The stanchion socket is formed under the head to hold the stanchion and has a blind hole. The locking cavity is formed in the stanchion socket and has an inner space to communicate with the blind hole in the stanchion socket.

The locking block is movably mounted inside the locking cavity.

The lever is attached pivotally to the body, presses the locking block against the stanchion or releases the locking block and is selectively pushed right or left. The quick-release connector can be quickly and easily attached to or detached from a support stand.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a transverse quick-release connector in accordance with the present invention;

FIG. 2 is an exploded perspective view of the transverse quick-release connector in FIG. 1;

FIG. 3 is a perspective view in partial section of the transverse quick-release connector in FIG. 1;

FIG. 4 is a top view in partial section of the transverse quick-release connector in FIG. 1 in a released position around a stanchion;

FIG. 5 is a top view of the transverse quick-release connector in FIG. 1 connected to a stanchion;

FIG. 6 is an explode perspective view of the transverse quick-release connector in FIG. 1 connecting a boom to a stanchion;

FIG. 7 is a perspective view of another embodiment of a transverse quick-release connector in accordance with the present invention;

FIG. 8 is an exploded perspective view of a microphone boom mounted on a stanchion in accordance with the prior art; and

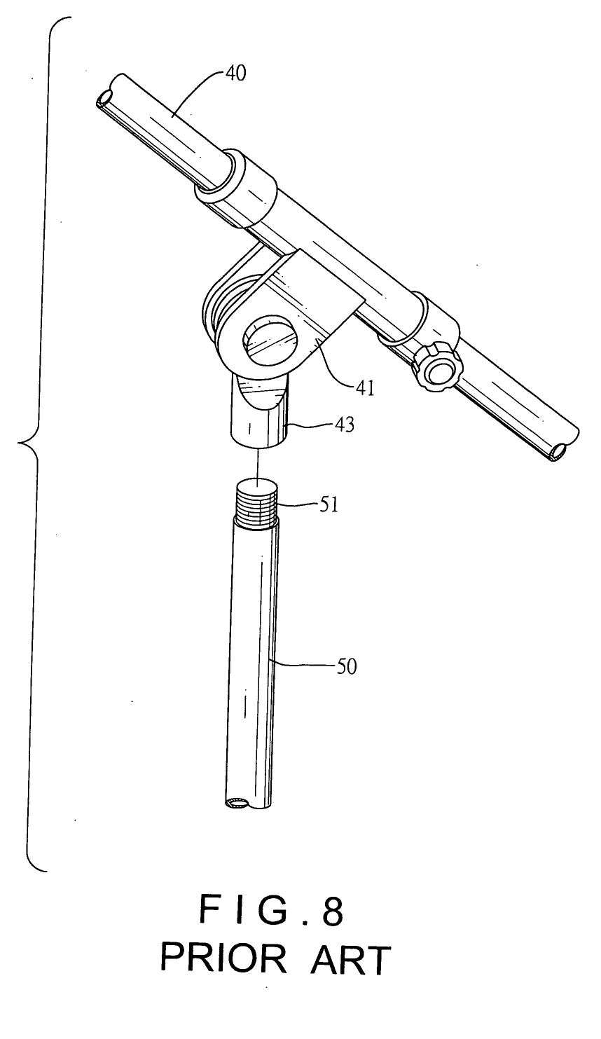

FIG. 9 is a perspective view of a longitudinal quick-release connector in accordance with the prior art.

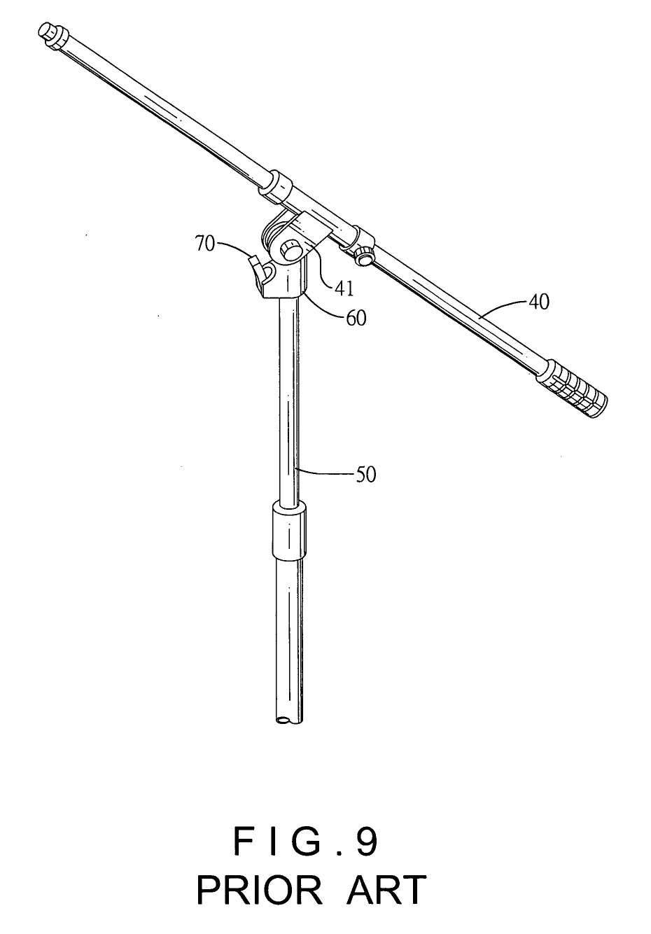

### DETAILED DESCRIPTION OF THE PREFERRED EMBODIMENT

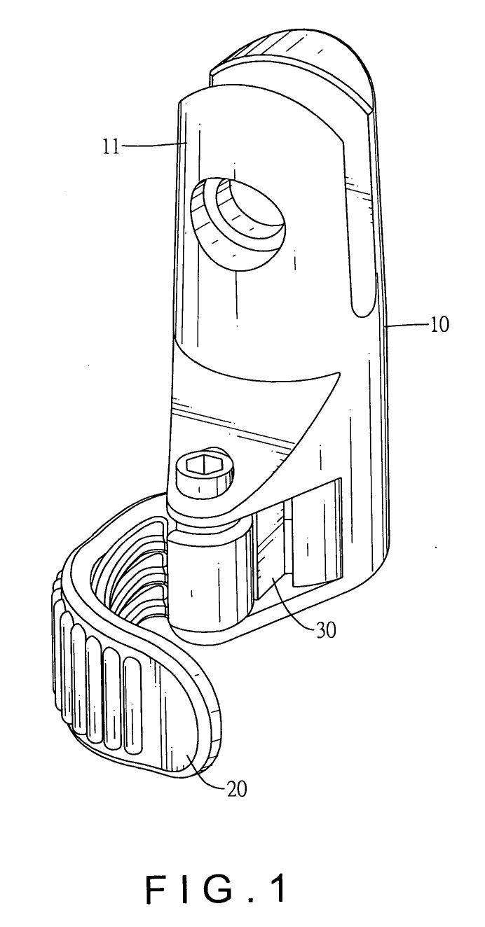

With reference to FIG. 1, a transverse quick-release connector in accordance with the present invention used to connect an accessory to a stanchion comprises a body (10), a locking block (30) and a lever (20).

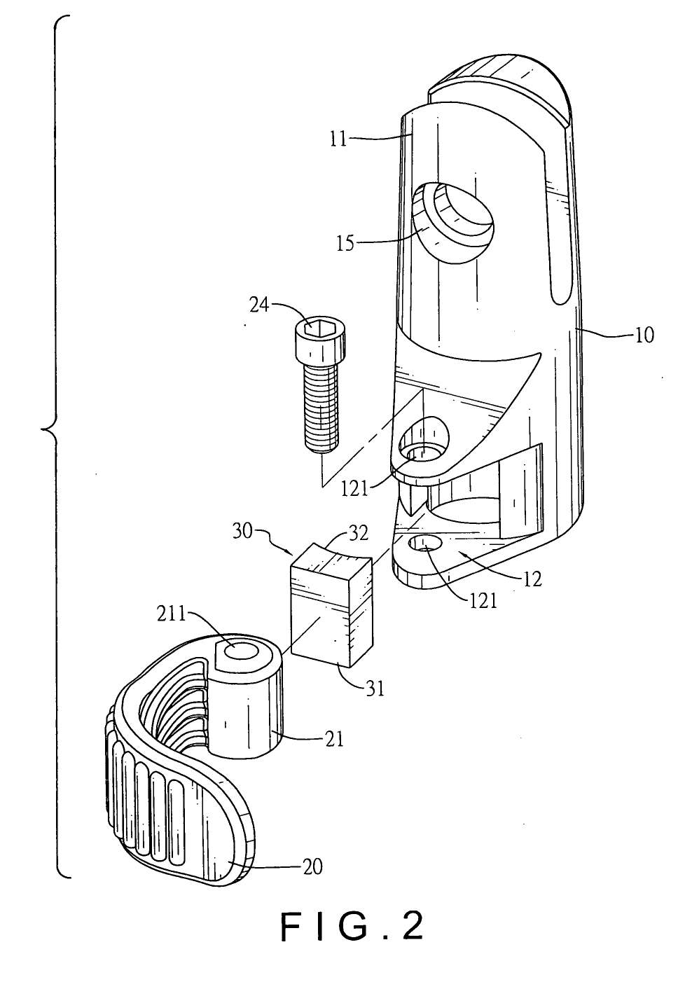

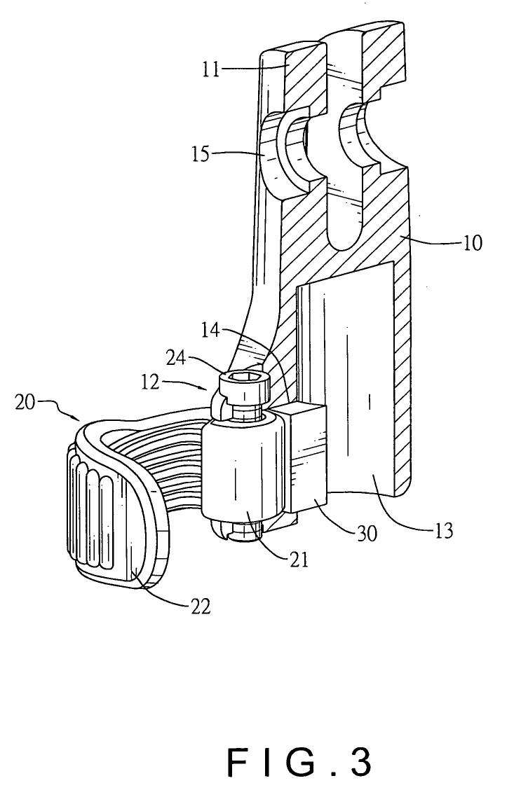

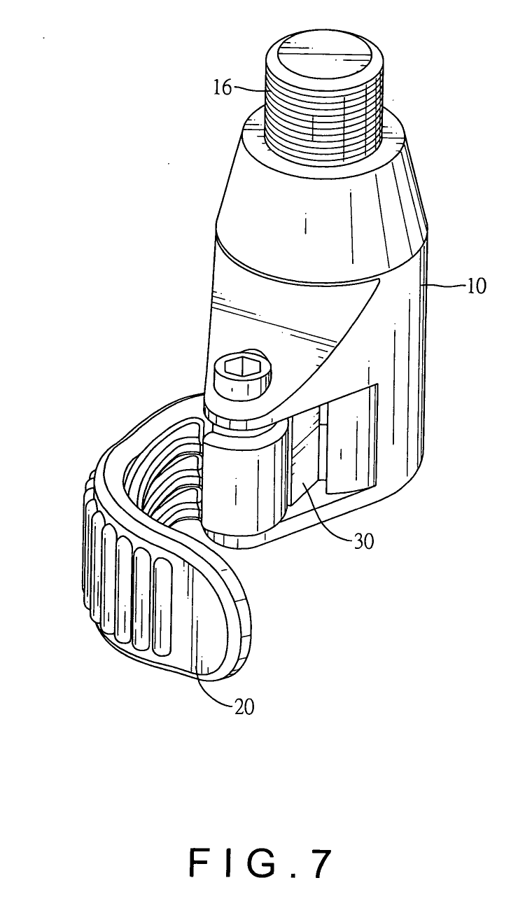

With further reference to FIGS. 2, 3 and 7, the body (10) is composed of a head (not numbered), a stanchion socket (13) and a locking cavity (12). The head may be a bracket (11) or a threaded post (16) to correspond to different adapters. The bracket (11) has an inner space and may have two central holes (15). The two central holes (15) are formed transversely through the bracket (11) and are aligned. The stanchion socket (13) has an external surface and a blind hole and is formed under the bracket (11). The locking cavity (12) is formed in the external surface of the stanchion socket (13) and has a top, a bottom, an inner space and two optional pivot holes (121). The inner space has a transverse channel (14) with a transverse length and communicates with the blind hole in the stanchion socket (13). The pivot holes (121) are formed respectively through the top and the bottom of the locking cavity (12).

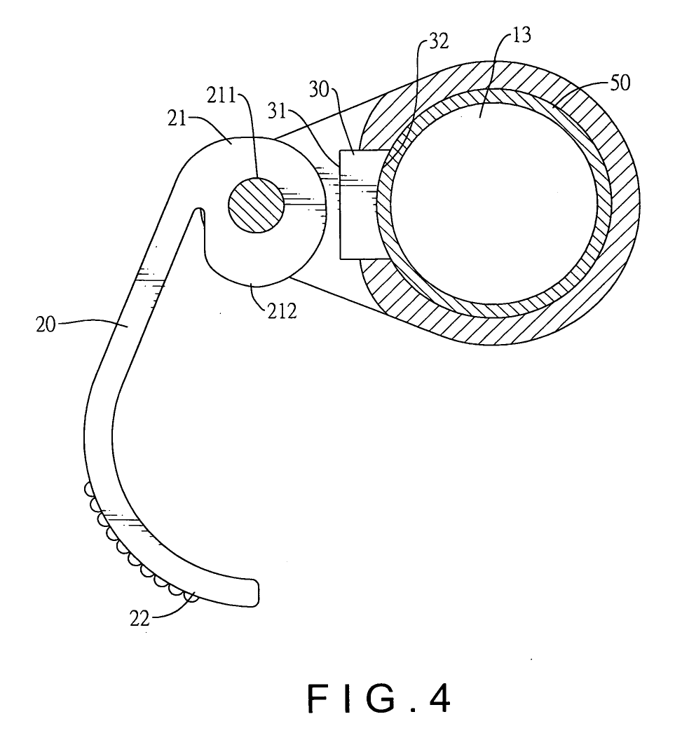

With further reference to FIG. 4, the locking block (30) is slidably mounted in the channel (14) and has an inner end, an outer end, an optional flat face (31) and an optional concave face (32). The inner end faces the blind hole in the stanchion socket (30). The flat face (31) is formed on the outer end. The concave face (32) is formed on the inner end and corresponds to the stanchion (50).

The lever (20) is pivotally mounted in the locking cavity (12) to press the locking block (30) and has a pivot end (21), a tab (22) and an optional pivot pin (24). The pivot end (21) faces the outer end of the locking block (30), is mounted pivotally in the locking cavity (12) and has an eccentric head with a pivot hole (211) and an enlarged lobe (212). The pivot hole (211) is defined through the eccentric head and is aligned with the pivot holes (121). A pivot pin (24) extends through the pivot holes (121, 211) to mount the lever (20) pivotally in the locking cavity (12). The tab (22) is formed oppositely to the pivot end (21) and is pushed selectively right or left and may be curved.

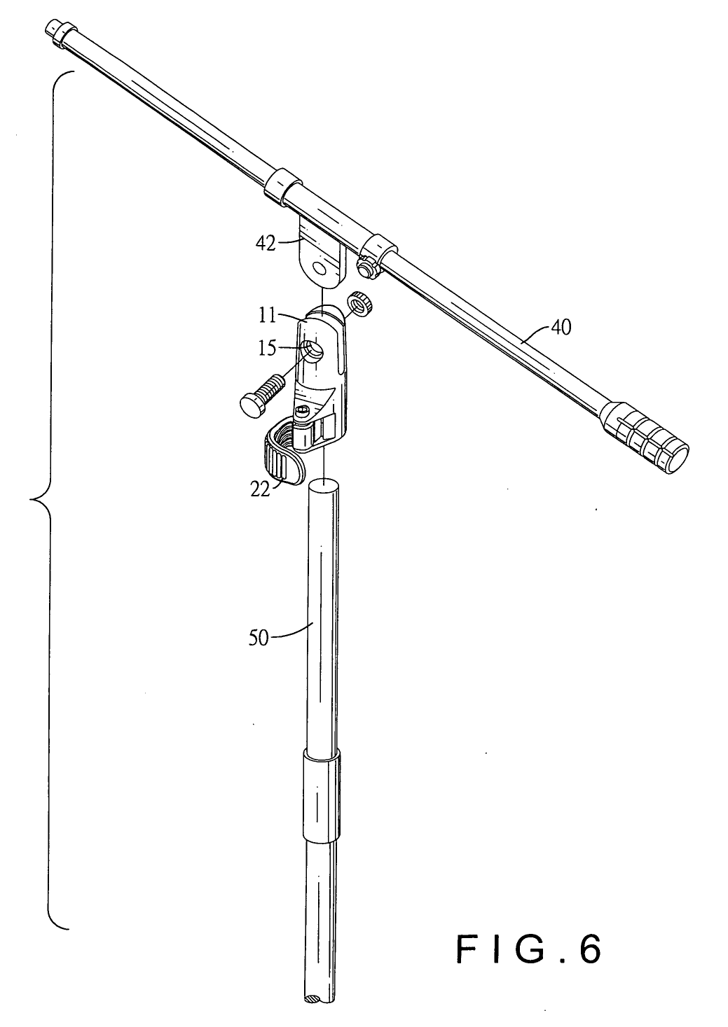

With further reference to FIG. 6, the eccentric head of the pivot end (21) does not press against the flat face (31) when the quick-release connector is in a released position. The concave face (32) of the locking block (30) does not press tightly against the stanchion (50). Therefore, the stanchion (50) can be easily inserted into or withdrawn from the blind hole in the stanchion socket (13).

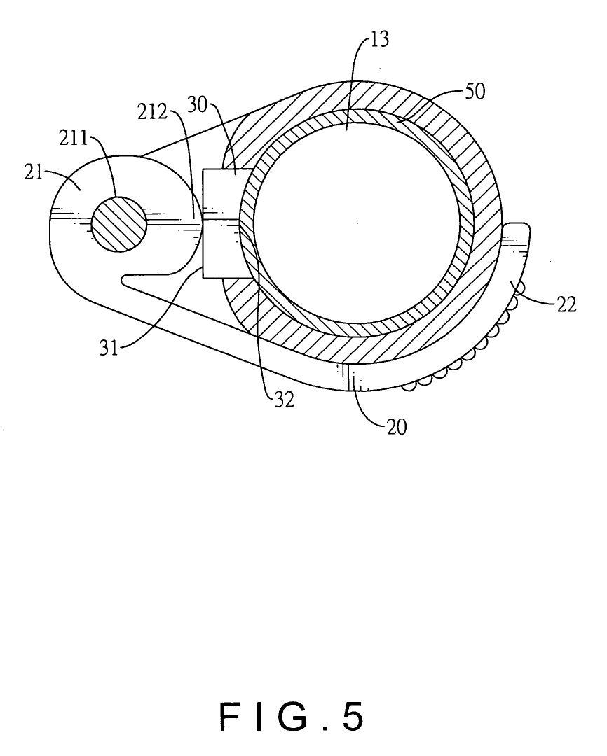

With further reference to FIG. 5, the transverse quick-release connector is locked by pushing the lever (20) right to make the eccentric head on the pivot end (21) rotate until the enlarged lobe (212) pushes the flat face (31) of the locking block (30). Then the concave face (32) of the locking block (30) presses tightly against the stanchion (50). Thereby, the stanchion (50) is held firmly in the stanchion socket (13) by the transverse quick-release connector.

After attaching the transverse quick-release connector to the stanchion (50), an ear (42) on the boom (40) is mounted securely in the bracket (11) with a nut and bolt to complete assembly of the stand.

According to foregoing description, an accessory can be attached quickly by attaching the transverse quick-release connector to the stanchion (50) first and then attaching the accessory to the bracket (11). The lever (20) releases or locks the locking block (30) to attach or detach the stanchion (50) by pushing the tab (22). When the quick-release connector is released, the stanchion (50) can be simply withdrawn from the stanchion socket (30) to detach the accessory. Therefore, neither the stanchion (50) nor the accessory needs to be rotated, to be attached or detached. Furthermore, the lever (20) is pushed right and left so an accessory will not obstruct rotation of the lever (20).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transverse quick-release connector comprising
a body having
a head;
a stanchion socket formed under the head and having an external surface and a blind hole; and
a locking cavity formed in the external surface of the stanchion socket and having
a top;
a bottom; and
an inner space having a transverse channel with a transverse length and communicating with the blind hole in the stanchion socket;
a locking block slidably mounted in the channel and having
an inner end facing the blind hole in the stanchion socket; and
an outer end; and
a lever pivotally mounted in the locking cavity and having
a pivot end facing the outer end of the locking block, pivotally mounted in the locking cavity and having
an eccentric head with an enlarged lobe; and
a pivot hole defined through the eccentric head; and
a tab formed oppositely to the pivot end and selectively pushed right and left.

2. The transverse quick-release device as claimed in claim 1, wherein the tab is curved.

3. The transverse quick-release device as claimed in claim 1, wherein
the locking block further comprises
a flat face formed on the outer end of the locking block; and
a concave face formed on the inner end of the locking block.

4. The transverse quick-release device as claimed in claim 2, wherein
the locking block further comprises
a flat face formed on the outer end of the locking block; and
a concave face formed on the inner end of the locking block.

5. The transverse quick-release device as claimed in claim 1, wherein
the head is a bracket having
an inner space; and
two central holes formed transversely in the bracket and aligned with each other;
the locking cavity further has two pivot holes formed respectively through the top and the bottom of the locking cavity and corresponding to the pivot hole in the pivot end; and
a pivot pin extends through the pivot holes to pivotally mounted the lever in the locking cavity.

6. The transverse quick-release device as claimed in claim 4, wherein
the head is a bracket having
an inner space; and
two central holes formed transversely in the bracket and aligned with each other;
the locking cavity further has two pivot holes formed respectively through the top and the bottom of the locking cavity and corresponding to the pivot hole in the pivot end; and
a pivot pin extends through the pivot holes to pivotally mounted the lever in the locking cavity.

7. The transverse quick-release device as claimed in claim 1, wherein the head is a threaded post.

8. The transverse quick-release device as claimed in claim 4, wherein the head is a threaded post.
